(19) United States
(12) Patent Application Publication
(10) Pub. No.: US 2025/0165132 A1
(43) Pub. Date: May 22, 2025

(54) METHOD AND RELATED DEVICE FOR PRESENTING CONTENT

(71) Applicant: Beijing Youzhuju Network Technology Co., Ltd., Beijing (CN)

(72) Inventors: Zhigang Ji, Beijing (CN); Xiaowei Li, Beijing (CN)

(21) Appl. No.: 18/954,350

(22) Filed: Nov. 20, 2024

(30) Foreign Application Priority Data
Nov. 21, 2023 (CN) 202311559218.6

(51) Int. Cl. G06F 3/04845; G06F 3/0483

(52) U.S. Cl. CPC G06F 3/04845; G06F 3/0483

(57) ABSTRACT

The present disclosure provides a method and a related device for presenting content. The method includes: presenting first content in a target presentation area of a target page; in response to an instruction for presenting second content, obtaining the second content; determining whether a size of the second content matches a size of the target presentation area; in response to the size of the second content not matching the size of the target presentation area, stretching the target presentation area; and presenting the second content in the stretched target presentation area.

### CROSS REFERENCE

This application claims priority of Chinese Patent Application No. CN202311559218.6, filed on Nov. 21, 2023, entitled ‘Method and Related Device for Presenting Content’.

### FIELD

The present disclosure relates to the field of computer technologies, and in particular, to methods and related devices for presenting content.

### BACKGROUND

In the related art, in order to increase the interestingness of an application, different types of content may be presented in a page.

However, the inventors of the present disclosure have found that since the content has different sizes and the presentation area of the page usually has a fixed size, some content with a specific size cannot be adapted to the size of the presentation area, which affects the presentation effect.

### SUMMARY

The present disclosure proposes methods and related devices for presenting content to solve or partially solve the above problems.

According to a first aspect of the present disclosure, there is provided a method for presenting content, comprising:
presenting first content in a target presentation area of a target page;
in response to an instruction for presenting second content, obtaining the second content;
determining whether a size of the second content matches a size of the target presentation area;
in response to the size of the second content not matching the size of the target presentation area, stretching the target presentation area; and
presenting the second content in the stretched target presentation area.

According to a second aspect of the present disclosure, there is provided an apparatus for presenting content, comprising:
a first presenting module, configured to present first content in a target presentation area of a target page;
an obtaining module, configured to obtain second content in response to an instruction for displaying the second content;
a determining module, configured to determine whether a size of the second content matches a size of the target presentation area;
a stretching module, configured to, in response to the size of the second content not matching the size of the target presentation area, stretch the target presentation area; and
a second presenting module, configured to present the second content in the stretched target presentation area.

According to a third aspect of the present disclosure, there is provided a computer device, comprising one or more processors, a memory; and one or more programs, wherein the one or more programs are stored in the memory and executed by the one or more processors, and the program comprises instructions for performing the method according to the first aspect.

According to a fourth aspect of the present disclosure, there is provided a non-transitory computer-readable storage medium containing a computer program, wherein the computer program, when executed by one or more processors, causes the processor to perform the method according to the first aspect.

According to a fifth aspect of the present disclosure, there is provided a computer program product, comprising computer program instructions, wherein the computer program instructions, when run on a computer, cause the computer to perform the method according to the first aspect.

The method and the related device for presenting content provided in the embodiments of the present disclosure can achieve a better presentation effect by stretching the presentation area and then presenting the second content when the size of the second content does not match the size of the presentation area.

### BRIEF DESCRIPTION OF THE DRAWINGS

In order to more clearly describe the technical solutions in the present disclosure or in the related art, the accompanying drawings for describing the embodiments or the related art will be briefly described below. It is clear that the accompanying drawings in the following description merely show some embodiments of the present disclosure, and a person of ordinary skill in the art may still derive other drawings from these accompanying drawings without creative efforts.

FIG. 1A shows a schematic diagram of an example system according to an embodiment of the present disclosure.

FIG. 1B shows a schematic diagram of an example page according to an embodiment of the present disclosure.

FIG. 1C shows a schematic diagram of another example page according to an embodiment of the present disclosure.

FIG. 2A shows a schematic flowchart of an example method according to an embodiment of the present disclosure.

FIG. 2B shows a schematic flowchart of an example method for presenting second content according to an embodiment of the present disclosure.

FIG. 3A shows a schematic diagram of an example page according to an embodiment of the present disclosure.

FIG. 3B shows a schematic diagram of another example page according to an embodiment of the present disclosure.

FIG. 3C shows a schematic diagram of another example page according to an embodiment of the present disclosure.

FIG. 3D shows a schematic diagram of another example page according to an embodiment of the present disclosure.

FIG. 3E shows a schematic diagram of another example page according to an embodiment of the present disclosure.

FIG. 3F shows a schematic diagram of another example page according to an embodiment of the present disclosure.

FIG. 4 shows a schematic diagram of an example page according to an embodiment of the present disclosure.

FIG. 5 shows a schematic diagram of a hardware structure of an example computer device according to an embodiment of the present disclosure.

FIG. 6 shows a schematic diagram of an example apparatus according to an embodiment of the present disclosure.

### DETAILED DESCRIPTION

In order to make the objectives, technical solutions, and advantages of the present disclosure clearer and more comprehensible, the present disclosure will be further described in detail below with reference to specific embodiments and the accompanying drawings.

It should be noted that the technical terms or scientific terms used in the embodiments of the present disclosure shall be the general meaning understood by those skilled in the art to which the present disclosure belongs, unless otherwise defined. The “first”, “second”, and similar words used in the embodiments of the present disclosure do not indicate any order, quantity, or importance, but are only used to distinguish different components. The similar words such as “include” or “have” mean that the elements or objects appearing before the word cover the elements or objects listed after the word and their equivalents, without excluding other elements or objects. The similar words such as “connect” or “connect to” are not limited to physical or mechanical connections, but may include electrical connections, whether direct or indirect. “Upper”, “lower”, “left”, “right”, etc. are only used to indicate relative position relationships, and when the absolute position of the described object changes, the relative position relationships may also change accordingly.

It would be appreciated that before the technical solutions of the embodiments of the present disclosure are used, the user is informed of the type, scope of use, and usage scenarios of the personal information involved, etc., through an appropriate manner, and the authorization of the user is obtained.

For example, in response to that a user's active request is received, prompt information is sent to the user to clearly prompt the user that the operation requested by the user will need to obtain and use the user's personal information. Therefore, the user may choose whether to provide personal information to the software or hardware such as an electronic device, an application, a server, or a storage medium that executes the operation of the technical solution of the present disclosure according to the prompt information.

As an optional but non-limiting implementation, the manner of sending prompt information to the user in response to receiving the user's active request may be, for example, a pop-up window, and the prompt information may be presented in the pop-up window in the form of text. In addition, the pop-up window may also carry a selection control for the user to select “agree” or “disagree” to provide personal information to the electronic device.

It would be appreciated that the above notification and user authorization process are only schematic and do not limit the implementation of the present disclosure, and other methods that meet the relevant laws and regulations may also be applied to the implementation of the present disclosure.

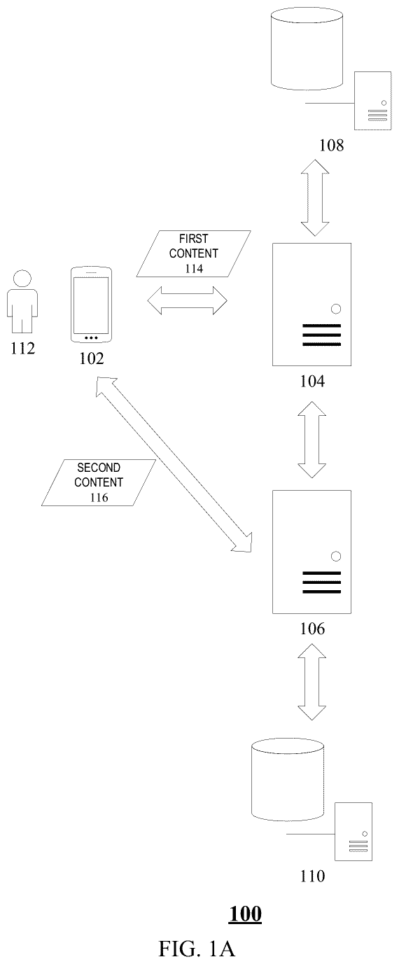

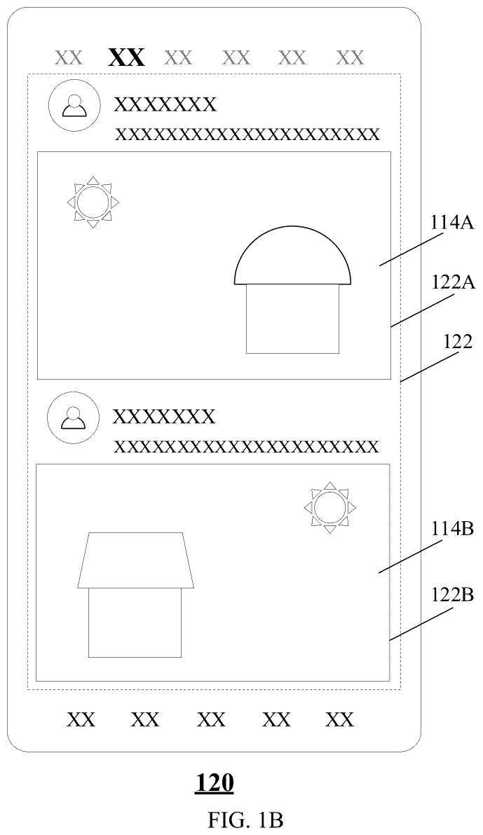

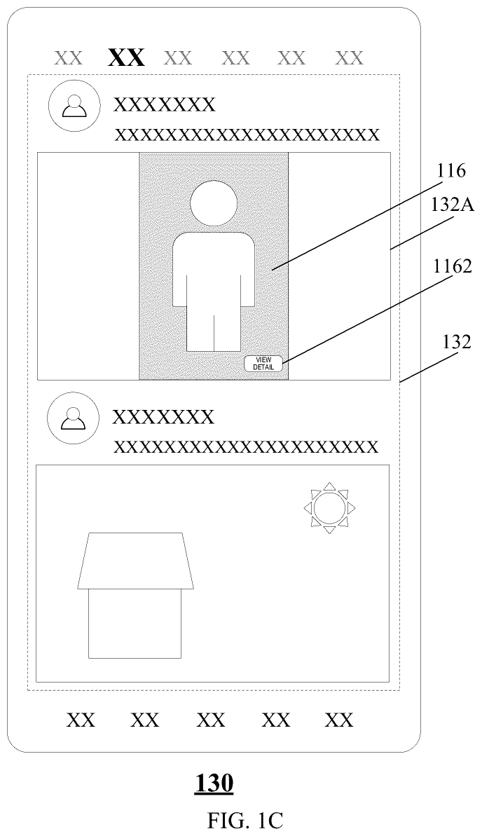

FIG. 1A shows a schematic diagram of an example system 100 according to an embodiment of the present disclosure.

As shown in FIG. 1A, the system 100 may include a terminal device 102 and a first server 104, and the first server 104 may return the required data to the terminal device 102 in response to a request from the terminal device 102. In some embodiments, as shown in FIG. 1A, the system 100 may further include a second server 106, and the second server 106 may provide services different from those of the first server 104. In some embodiments, the second server 106 may return the required data to the first server 104 in response to a request from the first server 104. As an optional embodiment, as shown in FIG. 1A, the second server 106 may directly respond to a request from the terminal device 102 and return the required data to the terminal device 102.

In some embodiments, as shown in FIG. 1A, the system 100 may further include a first data server 108 and a second database server 110. The first server 104 may use the first data server 108 to store data and may retrieve corresponding data from the first data server 108 based on requirements. The second server 106 may use the second database server 110 to store data and may retrieve corresponding data from the second database server 110 based on requirements.

A medium (for example, a network) that provides a communication link may be included among the terminal device 102, the first server 104, the second server 106, the first data server 108, and the second database server 110. The network may include various connection types, such as a wired, wireless communication link, or an optical fiber cable.

Various applications (APPs) may be installed on the terminal device 102, for example, an image processing application, a video application, a video conferencing application, a reading application, a social application, a payment application, a web browser, an instant messaging tool, and the like, and all these applications may be used to display content.

The terminal device 102 here may be hardware or software. If the terminal device 102 is hardware, it may be various electronic devices with a display screen, including but not limited to a smart phone, a tablet computer, an e-book reader, an MP3 player, a laptop computer, and a desktop (personal computer, PC) computer. If the terminal device 102 is software, it may be installed in the foregoing listed electronic devices. It may be implemented as multiple software or software modules (for example, used to provide distributed services), or may be implemented as a single software or software module. This is not specifically limited here.

The first server 104 and the second server 106 may be servers that provide various services, for example, a background server that provides support for various applications displayed on the terminal device 102. The first data server 108 and the second database server 110 may also be database servers that provide various services. It may be understood that when the first server 104 and the second server 106 may implement the related functions of the first data server 108 and the second database server 110, the first data server 108 and the second database server 110 may not be provided in the system 100.

The first server 104, the second server 106, and the first data server 108 and the second database server 110 may also be hardware or software. If they are hardware, they may be implemented as a distributed server cluster composed of a plurality of servers, or as a single server. If they are software, they may be implemented as a plurality of software programs or software modules (for example, used to provide distributed services), or may be implemented as single software or a single software module. This is not specifically limited here.

It should be noted that the data processing method provided in the embodiments of the present disclosure may be executed by the terminal device 102. It should be understood that the numbers of terminal devices, users, servers, and database servers in FIG. 1A are merely illustrative. Depending on implementation requirements, there may be any number of terminal devices, users, servers, and database servers.

The user 112 may use the service provided by the application installed on the terminal device 102. In an example scenario, the user 112 may open any application installed on the terminal device 102. In this case, the terminal device 102 may generate a content request corresponding to the application. For example, the first server 104 may be a server corresponding to the application, and the terminal device 102 may send the content request to the first server 104. After receiving the content request, the first server 104 may generate content data based on the content request.

In an example scenario, as shown in FIG. 1A, the terminal device 102 may receive first content 114 from the first server 104 for presentation, and if a condition for presenting the second content is triggered, the terminal device 102 may receive second content 116 from the second server 106 for presentation (or the second content 116 may be received from the first server 104 for presentation). In some embodiments, the first server 104 may be a server that can only provide some types of content, for example, the first server 104 can only provide the first content of a first type, and the second server 106 can provide the second content of a second type. Therefore, if the terminal device 102 requests the second content from the first server 104, the first server 104 may send a request for obtaining the second content of the second type to the second server 106, and after receiving the second content of the second type, the second content of the second type is returned to the terminal device 102. Optionally, the first server 104 may send the first content 114 and the second content 116 in the form of a data stream or a data packet.

Optionally, the first content 114 and the second content 116 may be various types of multimedia data, for example, video, audio, picture, photo, text, and the like.

For example, the first content 114 may be content of a first type, and the second content 116 may be content of a second type. The first type and the second type may be different. For example, the first content of the first type may be a video, and the second content of the second type may be an audio, a picture, a photo, text, or the like.

It should be noted that the classification of different types of content described here may not be limited to video, audio and picture. In some scenarios, the classification criterion of different types of content may be another criterion. For example, the first content of the first type may be dynamic content such as videos and audios, and the second content of the second type may be static content such as pictures, photos, and texts. In some scenarios, different types of content may refer to content with different natures. For example, the content of the first type may be content produced by a platform, for example, multimedia content such as videos and music, and the content of the second type may be content produced by a user, for example, a user post or an article. In some special scenarios, the content of the first type may be content (for example, video, audio, etc.) corresponding to a current page (or scenario) of an application, and the content of the second type may be an advertisement (in particular, an advertisement displayed in a portrait mode).

FIG. 1B shows a schematic diagram of an example page 120 according to an embodiment of the present disclosure.

As shown in FIG. 1B, the page 120 may be a page presented after the terminal device 102 opens an application. First content 114A and 114B may be presented in a content area 122 of the page 120. Optionally, the content area 122 may include presentation areas 122A and 122B, and the first content 114A and 114B may be respectively presented in the presentation areas 122A and 122B.

It can be seen from FIG. 1B that since the sizes of the first content 114A and 114B match the sizes of the presentation areas 122A and 122B, they can be presented relatively completely.

FIG. 1C shows a schematic diagram of another example page 130 according to an embodiment of the present disclosure.

As shown in FIG. 1C, if a condition for presenting the second content is triggered, the second content 116 may be presented in the display area 132A. It can be seen that since the size of the second content 116 does not match the size of the presentation area 132A, in order to ensure that the second content 116 can be completely presented in the presentation area 132A, it is necessary to forcefully adapt the size of the second content 116 to the size of the presentation area 132A. For example, the size of the second content 116 in a certain direction (for example, the width direction) is adapted to the presentation area 132A, and in another direction (for example, the length direction), the second content 116 cannot fill the presentation area 132A.

The advantage of such processing is that it is simple to implement and low cost. However, if the size of the second content 116 does not match the size of the presentation area, the area that cannot be filled can only be left blank. In addition, as shown in FIG. 1C, in some special scenarios, if the screen is not in the landscape state, the proportion of the presentation area 132A for presenting content is relatively small comparing to the content area 132 of the page 130, which will result in a smaller size of the second content 116 being presented, which seriously affects the interactive experience.

In view of this, in some embodiments of the present disclosure, a method for presenting content is provided. If the size of the second content does not match the size of the presentation area, the second content is presented after the presentation area is stretched, which can achieve a better presentation effect.

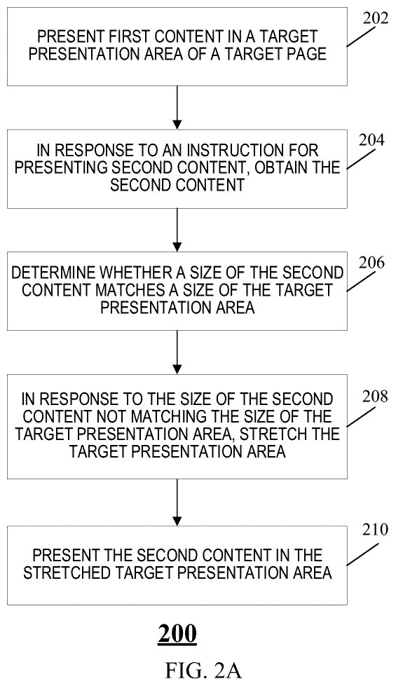

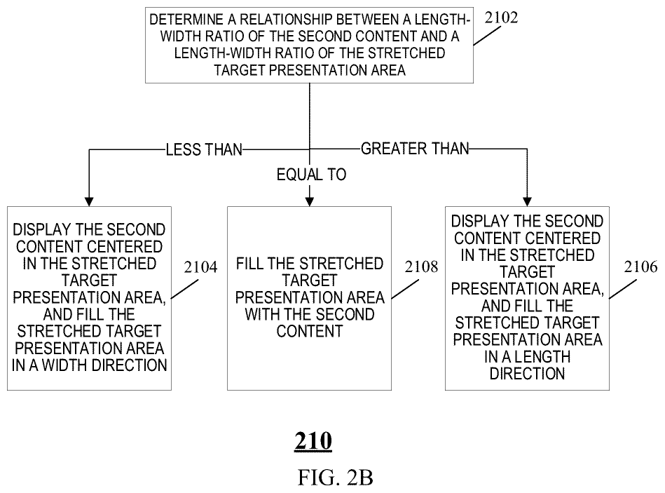

FIG. 2A shows a schematic flowchart of an example method 200 according to an embodiment of the present disclosure. The method 200 may be used to present the content. Optionally, the method 200 may be implemented by the system 100 of FIG. 1A.

As shown in FIG. 2A, the method 200 may further include the following steps.

In step 202, first content is displayed in a target presentation area of a target page.

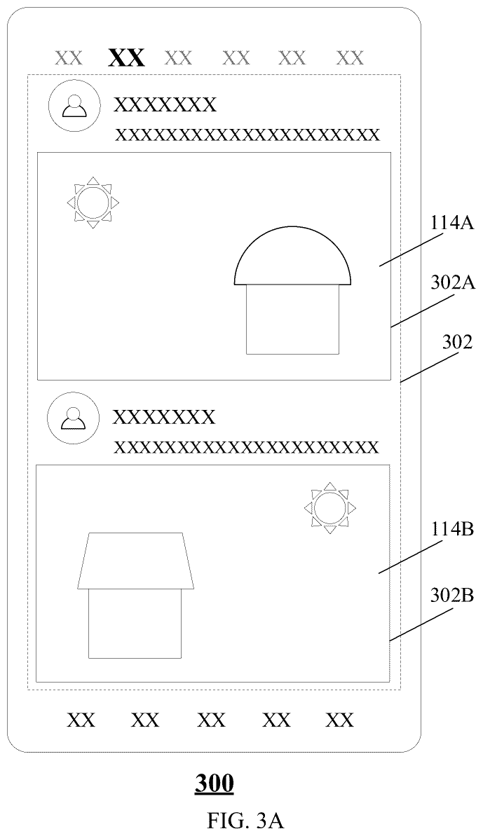

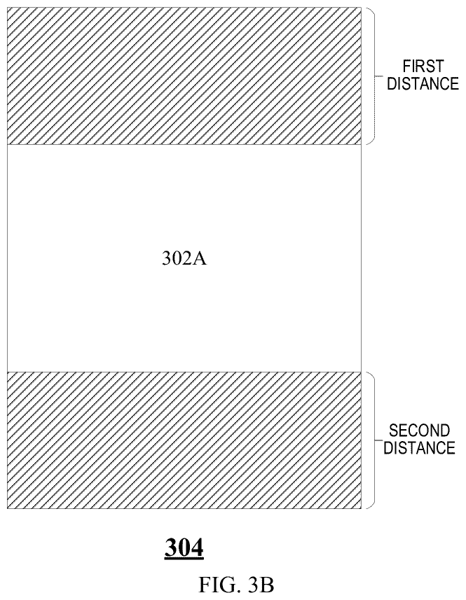

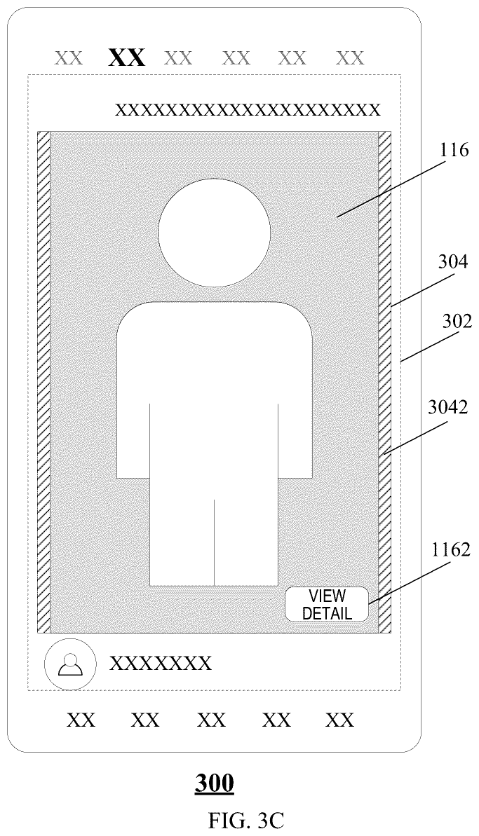

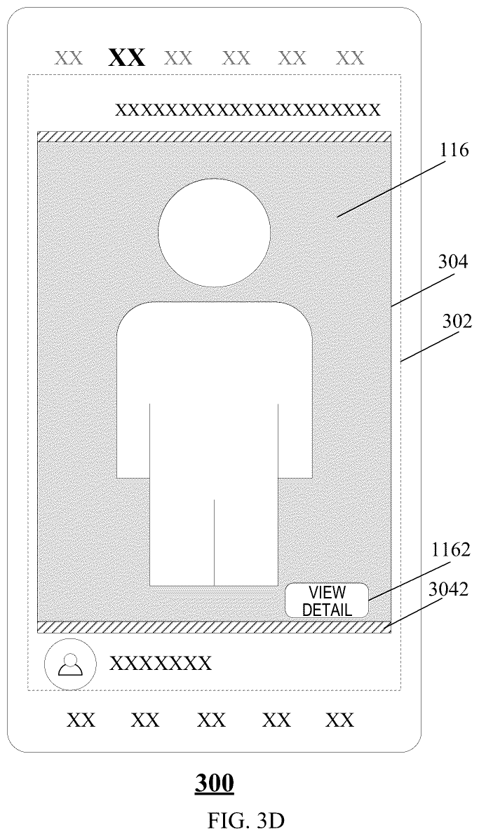

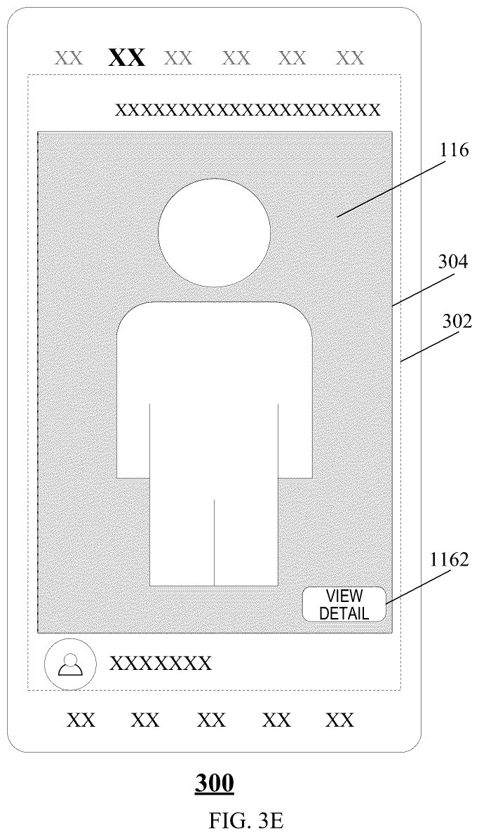

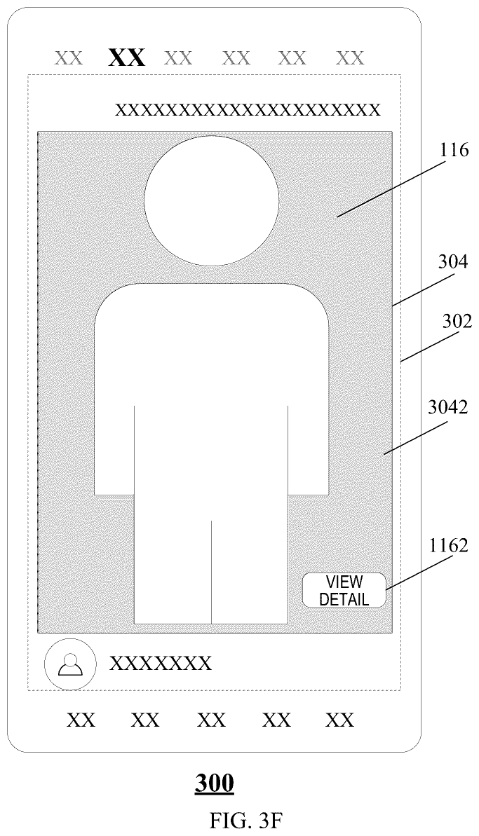

FIG. 3A shows a schematic diagram of an example page 300 according to an embodiment of the present disclosure.

As shown in FIG. 3A, the page 300 may include a content area 302, a navigation bar arranged above the content area 302, and a menu bar arranged below the content area 302.

As shown in FIG. 3A, the content area 302 may further include a plurality of presentation areas, for example, presentation areas 302A and 302B. The presentation areas 302A and 302B may respectively present first content 114A and 114B. Optionally, the first content 114A and 114B may be content of a first type, for example, dynamic content such as video and audio, content produced by a platform, content corresponding to a current page (or scenario) of an application, and the like.

The following describes an example in which the presentation area 302A is used as the target presentation area.

In step 204, in response to an instruction for presenting the second content, the second content 116 is obtained.

In an example scenario, the first content 114A may be a video, and the video may be in a non-playing state. Therefore, in the current state, a keyframe or a first frame of the first content 114A may be presented in the presentation area 302A. In this case, if the user wants to watch the video, the user may click on the first content 114A in the presentation area 302A (or click on a play button (not shown)) to give an instruction to play the video. As an example play mechanism, after receiving the instruction to play the video, the terminal device 102 may first insert the second content 116 for presentation. Therefore, it may be understood that in this case, the instruction to play the video may be considered as the instruction for presenting the second content.

In another example scenario, the first content 114A may be a video, and the video may be in a playing state. Therefore, in the current state, it may be presented according to the video frame sequence of the first content 114A in the presentation area 302A. In this case, if the user wants to pause the video, the user may click on the first content 114A in the presentation area 302A (or click on a pause button (not shown)) to give an instruction to pause the video. As an example play mechanism, after receiving the instruction to pause the video, the terminal device 102 may pause playing the video and may insert the second content 116 for presentation. Therefore, it may be understood that in this case, the instruction to pause the video may also be considered as the instruction for presenting the second content.

In another example scenario, the first content 114A is a video in a preview interface of a video application. When the user performs a sliding operation to place the first content 114A at a position where it can be played, the first content 114A may be automatically played. When the first content 114A is played to a specific position, the playing of the first content 114A may be paused and the first second content 116 may be inserted for presentation. It may be understood that the event that the first content 114A is played to the specific position may also be considered as the instruction for presenting the second content.

After receiving the instruction for presenting the second content, the terminal device 102 may obtain the second content 116.

Optionally, the terminal device 102 may obtain the second content 116 from the first server 104 or from the second server 106, and the specific obtaining manner is not limited.

After obtaining the second content 116, in step 206, it may be determined that whether a size of the second content matches a size of the target presentation area.

Optionally, whether the size of the second content 116 matches the size of the presentation area 302A may be determined based on a criterion that whether the second content 116 fills the presentation area 302A on the premise that the second content 116 is completely presented. As shown in FIG. 1C, on the premise that the second content 116 is completely presented, the presentation area 132A has a lot of blank space, and it may be considered that the size of the second content does not match the size of the presentation area.

As an optional embodiment, whether the two match may be determined by determining a proportion of an area of the presentation area occupied by the second content on the premise that the second content is completely presented. For example, if the proportion of the area of the presentation area occupied by the second content on the premise that the second content is completely presented is less than 60%, it may be considered that the sizes of the two do not match.

In a more common scenario, as shown in FIG. 1C, the size of the second content 116 may be designed for portrait screen use, while the first content 114A is designed for landscape screen use, and there is a large difference between the length-width ratios of the two. Therefore, in some embodiments, determining whether the size of the second content matches the size of the target presentation area may be implemented by determining whether a length-width ratio of the second content matches a length-width ratio of the target presentation area.

For example, for content designed for landscape screen use, the length-width ratio may be 4:3, 16:9, 21:9, 32:9, and the like, and for content designed for portrait screen use, the length-width ratio is generally 9:16. Therefore, by comparing the length-width ratios, it can be quickly determined whether the size of the second content matches the size of the presentation area.

In step 208, in response to the size of the second content not matching the size of the target presentation area, the target presentation area is stretched.

In this step, if it is determined that the size of the second content 116 does not match the size of the presentation area 302A, the presentation area 302A may be stretched, so that it can better present the second content 116.

In some embodiments, stretching the target presentation area may further include: in response to the length-width ratio of the second content 116 being less than the length-width ratio of the target presentation area 302A, stretching the target presentation area 302A in a width direction.

As shown in FIG. 1C, the length-width ratio of the second content 116 may be a length-width ratio designed for portrait screen use, for example, it may be 9:16, and the length-width ratio of the presentation area 302A may be a length-width ratio designed for landscape screen use, for example, 4:3, 16:9, 21:9, 32:9, and the like. Therefore, the length-width ratio of the second content 116 is less than the length-width ratio of the presentation area 302A, which indicates that the presentation area 302A needs to be stretched in the width direction (vertical direction in the figure).

In some embodiments, stretching the target presentation area in the width direction includes: stretching the target presentation area upward in the width direction by a first distance, and stretching the target presentation area downward in the width direction by a second distance.

FIG. 3B shows a schematic diagram of stretching a presentation area according to an embodiment of the present disclosure.

As shown in FIG. 3B, in this embodiment, the presentation area 302A may be stretched upward in the width direction by the first distance and downward in the width direction by the second distance to obtain the stretched presentation area 304.

Optionally, the first distance and the second distance may be calculated based on a size of a content area 302 of the page 300 and a size of the presentation area 302A. For example, the size of the content area 302 of the page 300 in the width direction is 120 mm, and the size of the presentation area 302A in the width direction is 30 mm, then a sum of the first distance and the second distance may be less than or equal to 90 mm, for example, the first distance and the second distance may be respectively set to 45 mm.

Although this is the case, the inventors of the present disclosure have found that since the sizes of the navigation bars and the menu bars of different applications are different, and the screen sizes of terminal devices 102 of different models also differ, the size of the content area 302 may also differ in different scenarios. In order to ensure that the stretched presentation area 304 can be completely presented in the content area 302 in any application of any terminal device, the first distance and the second distance may be set smaller. For example, generally, the size of the presentation area 302A in the width direction is 30 mm, and if the size of the stretched presentation area 304 in the width direction is 100 mm, it can meet the requirements of most scenarios. In this case, the sum of the first distance and the second distance may be set to be less than or equal to 70 mm, for example, the first distance and the second distance may be respectively set to 35 mm.

In some embodiments, after stretching the target presentation area, the method 200 further includes moving the stretched target presentation area to the middle of a content area of the target page, as shown in FIG. 3C.

It can be seen from FIG. 3A and FIG. 3B that after the presentation area 302A is stretched in the width direction, the stretched presentation area 304 will exceed the content area 302 from above, resulting in the presentation area 304 not being completely presented in the content area 302. Therefore, by moving the stretched presentation area 304 to the middle of the content area 302 of the page 300, it can be ensured that the stretched presentation area 304 is completely presented in the content area 302. In addition, through such processing, it can be ensured that the stretched presentation area 304 can be completely presented in the content area 302 in most scenarios.

According to the above embodiment, it may be understood that for the case where the position of the presentation area 302A is close to the top or bottom of the content area 302, the stretched presentation area 304 usually exceeds the content area 302, but for the case where the position of the presentation area 302A is originally close to the middle of the content area 302, the stretched presentation area 304 usually does not exceed the content area 302.

Therefore, as an optional embodiment, after stretching the target presentation area, the method 200 may further include: determining whether the stretched target presentation area exceeds the content area of the target page; and in response to the stretched target presentation area exceeding the content area of the target page, moving the stretched target presentation area to the middle of the content area of the target page. In this way, it can avoid performing the operation of moving the stretched target presentation area to the middle of the content area of the target page every time, and unnecessary steps are reduced, and the processing efficiency is improved.

Although this is the case, the inventors of the present disclosure have found that in most scenarios, the stretched presentation area 304 usually exceeds the content area 302. Therefore, as an alternative embodiment, the operation of moving the stretched target presentation area to the middle of the content area of the target page is performed after each stretching, so that the step of determining whether the stretched target presentation area exceeds the content area of the target page can be reduced. In general, the improvement in processing efficiency is more obvious.

In some embodiments, moving the stretched target presentation area to the middle of the content area of the target page includes: determining center coordinates of the content area 302; determining a center position of the stretched target presentation area 304; and aligning the center position of the stretched target presentation area with the center coordinates of the content area. In this way, the operation of moving the stretched target presentation area to the middle of the content area of the target page is completed, which is simple and easy to implement.

In step 210, the second content 116 is presented in the stretched target presentation area 304, as shown in FIG. 3C.

In some embodiments, as shown in FIG. 2B, step 210 of presenting the second content in the stretched target presentation area may further include the following steps.

In step 2102, determining a relationship between a length-width ratio of the second content and a length-width ratio of the stretched target presentation area.

In step 2104, in response to the length-width ratio of the second content being less than the length-width ratio of the stretched target presentation area, displaying the second content centered in the stretched target presentation area, and filling the stretched target presentation area in a width direction, as shown in FIG. 3C.

In step 2106, in response to the length-width ratio of the second content being greater than the length-width ratio of the stretched target presentation area, displaying the second content centered in the stretched target presentation area, and filling the stretched target presentation area in a length direction, as shown in FIG. 3D.

In step 2108, in response to the length-width ratio of the second content being equal to the length-width ratio of the stretched target presentation area, filling the stretched target presentation area with the second content, as shown in FIG. 3E.

In this way, determining how to present the second content 116 based on the relationship between the length-width ratio of the second content 116 and the length-width ratio of the stretched presentation area 304 may achieve a better presentation effect.

In some embodiments, presenting the second content in the stretched target presentation area further includes: performing fuzzing processing on an area in the stretched target presentation area in which the second content is not presented. As shown in FIG. 3D and FIG. 3E, the fuzzing processing may be performed on blank areas 3042 on both sides of the presentation area 304, which may achieve a better presentation effect.

In some embodiments, presenting the second content in the stretched target presentation area includes: displaying the second content centered in the stretched target presentation area, and filling the stretched target presentation area.

As shown in FIG. 3F, since the stretched presentation area 304 is well adapted to the size of the second content, in this embodiment, after the second content 116 is displayed centered in the presentation area 304, it fills the entire presentation area 304. Although an edge portion of the second content 116 is truncated, the presentation of the second content 116 will not be greatly affected. In addition, since the presentation area 304 is filled with the content, there will be no blank or fuzzy area, and the user will not easily find that the content is truncated, which will provide a better experience.

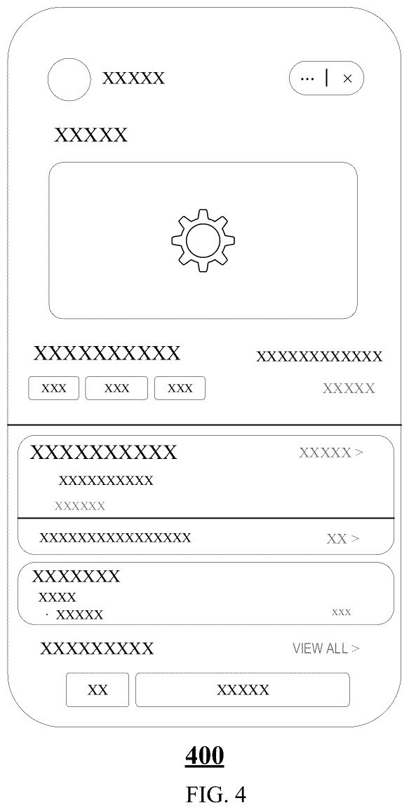

In some embodiments, the second content 116 is also provided with a trigger control 1162. By clicking on the trigger control 1162, the user can jump to another page 400 corresponding to the second content 116, as shown in FIG. 4. Depending on different functions of the trigger control 1162, the content displayed on the page 400 may be different, which is not specifically limited here.

It can be seen by comparing FIG. 3C and FIG. 1C that after the presentation area 302A is stretched to the presentation area 304, in addition to the second content 116 being enlarged, the trigger control 1162 is also enlarged accordingly, thereby improving the presentation effect and solving the problem of the trigger control 1162 being invisible or unclear.

In some embodiments, in response to the second content being completely presented (for example, a video is completely played), the presentation area 304 may be restored to the presentation area 302A, and then the first content 114A continues to be presented, so that the size of the presentation area is dynamically adjusted, thereby improving the interactive experience.

It can be seen from the above embodiments that the method for presenting content provided in the embodiments of the present disclosure breaks through the limitation on the idea of the traditional processing method in which the content does not match the presentation area, and changes the manner in which the second content is strongly dependent on the size of the presentation area to the dynamic adaptation of the playing area to the size of the content, so that the control of the two types of content over the size of the presentation area is raised to the same priority, thereby improving the interactive experience.

It should be noted that the method of the embodiment of the present disclosure may be performed by a single device, for example, a computer or a server. The method of this embodiment may also be applied to a distributed scenario, which is completed by multiple devices cooperating with each other. In such a distributed scenario, one of the multiple devices may only perform one or more steps of the method of the embodiment of the present disclosure, and the multiple devices will interact with each other to complete the method.

It should be noted that some embodiments of the present disclosure have been described above. Other embodiments are within the scope of the appended claims. In some cases, the actions or steps recited in the claims may be performed in a different order than in the embodiments described above and still achieve the desired results. In addition, the processes depicted in the accompanying drawings do not necessarily require the specific order or sequential order shown to achieve the desired results. In some implementations, multitasking and parallel processing may also be possible or may be advantageous.

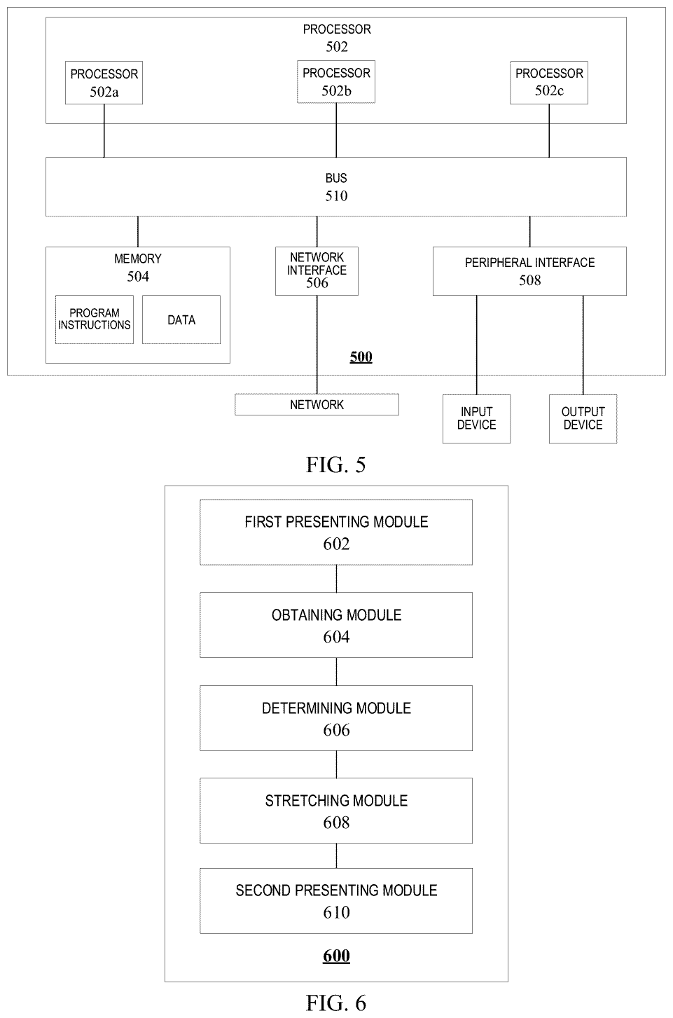

Embodiments of the present disclosure further provide a computer device for implementing the above method 200. FIG. 5 shows a schematic diagram of a hardware structure of an example computer device 500 according to an embodiment of the present disclosure. The computer device 500 may be used to implement the terminal device 102 of FIG. 1A, or may be used to implement the first server 104 and the second server 106 of FIG. 1A. In some scenarios, the computer device 500 may also be used to implement the first database server 108 and the second database server 110 of FIG. 1A.

As shown in FIG. 5, the computer device 500 may include a processor 502, a memory 504, a network module 506, a peripheral interface 508, and a bus 510. The processor 502, the memory 504, the network module 506, and the peripheral interface 508 are communicatively connected to each other inside the computer device 500 through the bus 510.

The processor 502 may be a central processing unit (CPU), a graphics processor, a neural network processor (NPU), a microcontroller (MCU), a programmable logic device, a digital signal processor (DSP), an application-specific integrated circuit (ASIC), or one or more integrated circuits. The processor 502 may be used to perform functions related to the technology described in the present disclosure. In some embodiments, the processor 502 may further include a plurality of processors integrated into a single logic component. For example, as shown in FIG. 5, the processor 502 may include a plurality of processors 502a, 502b, and 502c.

The memory 504 may be configured to store data (for example, instructions, computer code, etc.). As shown in FIG. 5, the data stored in the memory 504 may include program instructions (for example, program instructions for implementing the method 200 of the embodiment of the present disclosure) and data to be processed (for example, the memory may store configuration files of other modules, etc.). The processor 502 may also access the program instructions and data stored in the memory 504 and execute the program instructions to operate on the data to be processed. The memory 504 may include a volatile storage device or a non-volatile storage device. In some embodiments, the memory 504 may include a random-access memory (RAM), a read-only memory (ROM), an optical disc, a magnetic disc, a hard disc, a solid state drive (SSD), a flash memory, a memory stick, and the like.

The network interface 506 may be configured to provide communication with other external devices for the computer device 500 via a network. The network may be any wired or wireless network capable of transmitting and receiving data. For example, the network may be a wired network, a local wireless network (for example, Bluetooth, Wi-Fi, near field communication (NFC), etc.), a cellular network, the Internet, or a combination thereof. It may be understood that the type of the network is not limited to the specific examples described above.

The peripheral interface 508 may be configured to connect the computer device 500 to one or more peripheral devices to implement information input and output. For example, the peripheral devices may include input devices such as a keyboard, a mouse, a touchpad, a touchscreen, a microphone, various sensors, and the like, and output devices such as a display, a speaker, a vibrator, an indicator light, and the like.

The bus 510 may be configured to transmit information between various components (for example, the processor 502, the memory 504, the network interface 506, and the peripheral interface 508) of the computer device 500, such as an internal bus (for example, a processor-memory bus), an external bus (a USB port, a PCI-E bus), and the like.

It should be noted that although the architecture of the computer device 500 described above shows only the processor 502, the memory 504, the network interface 506, the peripheral interface 508, and the bus 510, in the specific implementation process, the architecture of the computer device 500 may further include other components necessary for normal operation. In addition, those skilled in the art may understand that the architecture of the computer device 500 may also include only components necessary for implementing the solution of the embodiment of the present disclosure, and does not necessarily include all the components shown in the figure.

Embodiments of the present disclosure further provide an apparatus for presenting content. FIG. 6 shows a schematic diagram of an example apparatus 600 according to an embodiment of the present disclosure. As shown in FIG. 6, the apparatus 600 may be used to implement the method 200, and may further include the following modules.
a first presenting module 602, configured to present first content in a target presentation area of a target page;
an obtaining module 604, configured to, in response to an instruction for presenting second content, obtain the second content;
a determining module 606, configured to determine whether a size of the second content matches a size of the target presentation area;
a stretching module 608, configured to, in response to the size of the second content not matching the size of the target presentation area, stretch the target presentation area; and
a second presenting module 610, configured to present the second content in the stretched target presentation area.

In some embodiments, the determining module 606 is configured to determine whether a length-width ratio of the second content matches a length-width ratio of the target presentation area.

In some embodiments, the stretching module 608 is configured to, in response to the length-width ratio of the second content being less than the length-width ratio of the target presentation area, stretch the target presentation area in a width direction.

In some embodiments, the stretching module 608 is configured to stretching the target presentation area upward in the width direction by a first distance, and stretch the target presentation area downward in the width direction by a second distance.

In some embodiments, the stretching module 608 is configured to move the stretched target presentation area to the middle of a content area of the target page.

In some embodiments, the stretching module 608 is configured to determine center coordinates of the content area; determine a center position of the stretched target presentation area; and align the center position of the stretched target presentation area with the center coordinates of the content area.

In some embodiments, the stretching module 608 is configured to, in response to the stretched target presentation area exceeding a content area of the target page, move the stretched target presentation area to the middle of the content area of the target page.

In some embodiments, the second presenting module 610 is configured to:
determine a relationship between a length-width ratio of the second content and a length-width ratio of the stretched target presentation area;
in response to the length-width ratio of the second content being less than the length-width ratio of the stretched target presentation area, display the second content centered in the stretched target presentation area, and fill the stretched target presentation area in a width direction;
in response to the length-width ratio of the second content being greater than the length-width ratio of the stretched target presentation area, display the second content centered in the stretched target presentation area, and fill the stretched target presentation area in a length direction; and
in response to the length-width ratio of the second content being equal to the length-width ratio of the stretched target presentation area, fill the stretched target presentation area with the second content.

In some embodiments, the second presenting module 610 is configured to perform fuzzing processing on an area in the stretched target presentation area in which the second content is not displayed.

In some embodiments, the second display module 610 is configured to display the second content centered in the stretched target presentation area, and fill the stretched target presentation area.

For the convenience of description, when the above apparatus is described, the functions are divided into various modules and are described respectively. Of course, when implementing the present disclosure, the functions of the modules may be implemented in the same or multiple software and/or hardware.

The apparatus of the above embodiment is used to implement the corresponding method 200 in any of the foregoing embodiments, and has the beneficial effects of the corresponding method embodiments, which will not be repeated here.

Based on the same inventive concept, corresponding to the method of any of the above embodiments, the present disclosure further provides a non-transitory computer-readable storage medium storing computer instructions for causing a computer to perform the method 200 as described in any of the above embodiments.

The computer-readable medium in this embodiment includes permanent and non-permanent, movable and non-removable media, which can implement information storage by any method or technology. The information may be computer-readable instructions, data structures, program modules, or other data. Examples of computer storage media include, but are not limited to, phase change memory (PRAM), static random access memory (SRAM), dynamic random access memory (DRAM), other types of random access memory (RAM), read-only memory (ROM), electrically erasable programmable read-only memory (EEPROM), flash memory or other memory technologies, compact disc read-only memory (CD-ROM), digital versatile disc (DVD) or other optical storage, magnetic cassette tape, magnetic tape and magnetic disk storage or other magnetic storage devices or any other non-transmission medium, which can be used to store information accessible by a computing device.

The computer instructions stored in the storage medium of the above embodiment are used to cause the computer to perform the method 200 as described in any of the above embodiments, and have the beneficial effects of the corresponding method embodiments, which will not be repeated here.

Based on the same inventive concept, corresponding to the method 200 of any of the above embodiments, the present disclosure further provides a computer program product, which includes a computer program. In some embodiments, the computer program is executable by one or more processors to cause the processors to perform the method 200. The processor that performs the corresponding step corresponding to each step in each embodiment of the method 200 may belong to the corresponding execution subject.

The computer program product of the above embodiment is used to cause the processor to perform the method 200 as described in any of the above embodiments, and has the beneficial effects of the corresponding method embodiments, which will not be repeated here.

Those of ordinary skill in the art should understand that the discussions of any of the above embodiments are exemplary only, and are not intended to imply that the scope of the present disclosure (including claims) is limited to these examples; under the idea of the present disclosure, the above embodiments or the technical features in different embodiments may also be combined, and the steps may be implemented in any order, and there are many other variations of different aspects of the embodiments of the present disclosure as described above, which are not provided in detail for the purpose of brevity.

In addition, in order to simplify the description and discussion, and in order not to make the embodiments of the present disclosure difficult to understand, well-known power/ground connections to integrated circuit (IC) chips and other components may or may not be shown in the provided drawings. Further, the apparatus may be shown in block diagram form in order to avoid making the embodiments of the present disclosure difficult to understand, and this also takes into account the fact that the details of the implementation of these block diagram apparatuses are highly dependent on the platform on which the embodiments of the present disclosure will be implemented (that is, these details should be completely within the understanding of those skilled in the art). In the case where specific details (e.g., circuits) are set forth in order to describe the exemplary embodiments of the present disclosure, it will be apparent to those skilled in the art that the embodiments of the present disclosure may be implemented without these specific details or with variations of these specific details. Therefore, the descriptions are to be regarded as illustrative rather than restrictive.

Although the present disclosure has been described in conjunction with specific embodiments of the present disclosure, many alternatives, modifications and variations of these embodiments will be apparent to those of ordinary skill in the art from the foregoing description. For example, other memory architectures (such as dynamic RAM (DRAM)) may use the embodiments discussed.

The embodiments of the present disclosure are intended to cover all such alternatives, modifications and variations falling within the broad scope of the appended claims. Therefore, any omissions, modifications, equivalent replacements, improvements, etc. made within the spirit and principles of the embodiments of the present disclosure should be included within the scope of protection of the present disclosure.

I/We claim:

1. A method for presenting content, comprising:
presenting first content in a target presentation area of a target page;
in response to an instruction for presenting second content, obtaining the second content;
determining whether a size of the second content matches a size of the target presentation area;
in response to the size of the second content not matching the size of the target presentation area, stretching the target presentation area; and
presenting the second content in the stretched target presentation area.

2. The method according to claim 1, wherein determining whether the size of the second content matches the size of the target presentation area comprises:
determining whether a length-width ratio of the second content matches a length-width ratio of the target presentation area.

3. The method according to claim 2, wherein stretching the target presentation area comprises:
in response to the length-width ratio of the second content being less than the length-width ratio of the target presentation area, stretching the target presentation area in a width direction.

4. The method according to claim 3, wherein stretching the target presentation area in the width direction comprises:
stretching the target presentation area upward in the width direction by a first distance, and stretching the target presentation area downward in the width direction by a second distance.

5. The method according to claim 1, wherein after stretching the target presentation area, the method further comprises:
moving the stretched target presentation area to the middle of a content area of the target page.

6. The method according to claim 5, wherein moving the stretched target presentation area to the middle of the content area of the target page comprises:
determining center coordinates of the content area;
determining a center position of the stretched target presentation area; and
aligning the center position of the stretched target presentation area with the center coordinates of the content area.

7. The method according to claim 4, wherein after stretching the target presentation area, the method further comprises:
in response to the stretched target presentation area exceeding a content area of the target page, moving the stretched target presentation area to the middle of the content area of the target page.

8. The method according to claim 1, wherein presenting the second content in the stretched target presentation area comprises:
determining a relationship between a length-width ratio of the second content and a length-width ratio of the stretched target presentation area;
in response to the length-width ratio of the second content being less than the length-width ratio of the stretched target presentation area, displaying the second content centered in the stretched target presentation area, and filling the stretched target presentation area in a width direction;
in response to the length-width ratio of the second content being greater than the length-width ratio of the stretched target presentation area, displaying the second content centered in the stretched target presentation area, and filling the stretched target presentation area in a length direction; and
in response to the length-width ratio of the second content being equal to the length-width ratio of the stretched target presentation area, filling the stretched target presentation area with the second content.

9. The method according to claim 8, wherein presenting the second content in the stretched target presentation area further comprises:
performing fuzzing processing on an area in the stretched target presentation area in which the second content is not presented.

10. The method according to claim 1, wherein presenting the second content in the stretched target presentation area comprises:
displaying the second content centered in the stretched target presentation area, and filling the stretched target presentation area.

11. A computer device, comprising one or more processors, a memory; and one or more programs, wherein the one or more programs are stored in the memory and executed by the one or more processors, and the program comprises instructions for performing a method for presenting content, comprising:
presenting first content in a target presentation area of a target page;
in response to an instruction for presenting second content, obtaining the second content;
determining whether a size of the second content matches a size of the target presentation area;
in response to the size of the second content not matching the size of the target presentation area, stretching the target presentation area; and
presenting the second content in the stretched target presentation area.

12. The computer device of claim 11, wherein determining whether the size of the second content matches the size of the target presentation area comprises:
determining whether a length-width ratio of the second content matches a length-width ratio of the target presentation area.

13. The computer device of claim 12, wherein stretching the target presentation area comprises:
in response to the length-width ratio of the second content being less than the length-width ratio of the target presentation area, stretching the target presentation area in a width direction.

14. The computer device of claim 13, wherein stretching the target presentation area in the width direction comprises:
stretching the target presentation area upward in the width direction by a first distance, and stretching the target presentation area downward in the width direction by a second distance.

15. The computer device of claim 11, wherein after stretching the target presentation area, the method further comprises:
moving the stretched target presentation area to the middle of a content area of the target page.

16. The computer device of claim 15, wherein moving the stretched target presentation area to the middle of the content area of the target page comprises:
determining center coordinates of the content area;
determining a center position of the stretched target presentation area; and
aligning the center position of the stretched target presentation area with the center coordinates of the content area.

17. The computer device of claim 14, wherein after stretching the target presentation area, the method further comprises:
in response to the stretched target presentation area exceeding a content area of the target page, moving the stretched target presentation area to the middle of the content area of the target page.

18. The computer device of claim 11, wherein presenting the second content in the stretched target presentation area comprises:
determining a relationship between a length-width ratio of the second content and a length-width ratio of the stretched target presentation area;
in response to the length-width ratio of the second content being less than the length-width ratio of the stretched target presentation area, displaying the second content centered in the stretched target presentation area, and filling the stretched target presentation area in a width direction;
in response to the length-width ratio of the second content being greater than the length-width ratio of the stretched target presentation area, displaying the second content centered in the stretched target presentation area, and filling the stretched target presentation area in a length direction; and
in response to the length-width ratio of the second content being equal to the length-width ratio of the stretched target presentation area, filling the stretched target presentation area with the second content.

19. The computer device of claim 18, wherein presenting the second content in the stretched target presentation area further comprises:
performing fuzzing processing on an area in the stretched target presentation area in which the second content is not presented.

20. A non-transitory computer-readable storage medium containing a computer program, wherein the computer program, when executed by one or more processors, causes the processor to perform a method for presenting content, comprising:
presenting first content in a target presentation area of a target page;
in response to an instruction for presenting second content, obtaining the second content;
determining whether a size of the second content matches a size of the target presentation area;
in response to the size of the second content not matching the size of the target presentation area, stretching the target presentation area; and
presenting the second content in the stretched target presentation area.
